(19) United States
(12) Patent Application Publication
(10) Pub. No.: US 2018/0164866 A1
(43) Pub. Date: Jun. 14, 2018

(54) LOW-POWER ARCHITECTURE FOR SPARSE NEURAL NETWORK

(71) Applicant: QUALCOMM Incorporated, San Diego, CA (US)

(72) Inventors: Yatish Girish TURAKHIA, Stanford, CA (US); Javid JAFFARI, San Diego, CA (US); Amrit PANDA, San Diego, CA (US); Karamvir CHATHA, San Diego, CA (US)

(21) Appl. No.: 15/377,858

(22) Filed: Dec. 13, 2016

(51) Int. Cl. G06F 1/32; G06N 3/02

(52) U.S. Cl. CPC G06F 1/3206; G06N 3/02

(57) ABSTRACT

A method, a computer-readable medium, and an apparatus for reducing power consumption of a neural network are provided. The apparatus may retrieve, from a tag storage, at least one tag value of a first tag value for a weight in the neural network or a second tag value for an activation in the neural network. The first tag value may indicate whether the weight is zero and the second tag value may indicate whether the activation is zero. The weight and the activation are to be loaded to a multiplier of a multiplier-accumulator unit as a pair of operands. The apparatus may determine whether the at least one tag value indicates a zero value. The apparatus may disable loading the weight and the activation to the multiplier when the at least one tag value indicates a zero value. The apparatus may disable updating of zero-value activations.

### BACKGROUND

### Field

The present disclosure relates generally to computing systems for artificial neural networks, and more particularly, to hardware accelerators for deep neural networks.

### Background

An artificial neural network, which may include an interconnected group of artificial neurons, may be a computational device or may represent a method to be performed by a computational device. Artificial neural networks may have corresponding structure and/or function in biological neural networks. However, artificial neural networks may provide innovative and useful computational techniques for certain applications in which traditional computational techniques may be cumbersome, impractical, or inadequate. Because artificial neural networks may infer a function from observations, such networks may be particularly useful in applications where the complexity of the task or data makes the design of the function by conventional techniques burdensome.

In computing, hardware acceleration is the use of computer hardware to perform some functions more efficiently than is possible in software running on a more general-purpose CPU. The hardware that performs the acceleration may be referred to as a hardware accelerator. Hardware accelerators may improve the execution of a specific algorithm by allowing greater concurrency, having specific data-paths for temporaries in the algorithm, and possibly reducing the overhead of instruction control.

Convolutional neural networks are a type of feed-forward artificial neural network. Convolutional neural networks may include collections of neurons that each has a receptive field and that collectively tile an input space. Convolutional neural networks (CNNs) have numerous applications. In particular, CNNs have broadly been used in the area of pattern recognition and classification.

Deep convolution neural networks (DCNs) have shown great performance in classification problems (e.g. image recognition). Dedicated hardware accelerators may be built to enable various applications of DCN technology in areas like mobile computing and cloud computing. Power-intensive operations in DCNs may be matrix-matrix multiplication and convolution.

Several technologies may reduce the computational overhead and improve the quality of the DCN classifiers. However, such technologies may lead to increased sparsity of the multiplication operands (e.g., higher percentage of zero-valued operands because of the reduced number of non-zero operands). For example, weight pruning may lead to around 30-70% sparsity in a DCN. The use of rectified linear unit (ReLU) activation may cause around 50% sparsity in a DCN. Dropouts of DCNs (for training only) may lead to 25-75% sparsity in the DCNs. The sparsity caused by weight pruning may be static sparsity, and the sparsity caused by ReLU and dropout may be dynamic sparsity. A neural network with high percentage of zero-valued operands may be referred to as a sparse neural network.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Several technologies may reduce the computational overhead and improve the quality of the DCN classifiers. However, these technologies may lead to increased sparsity of the multiplication operands. A hardware accelerator design may take sparsity into account to reduce power consumption. For example, a hardware accelerator may be configured to avoid fetching zero-valued operands, avoid multiplying by zero-valued operands, and avoid accumulating zero-valued operands.

In an aspect of the disclosure, a method, a computer-readable medium, and an apparatus for reducing power consumption of a neural network are provided. The apparatus may include a hardware accelerator. The apparatus may retrieve, from a tag storage, at least one tag value of a first tag value for a weight in the neural network or a second tag value for an activation in the neural network. The first tag value may indicate whether the weight is zero and the second tag value may indicate whether the activation is zero. The weight and the activation may be loaded to a multiplier of a multiplier-accumulator (MAC) unit as a pair of operands. The apparatus may determine whether the at least one tag value indicates a zero value. The apparatus may disable loading the weight and the activation to the multiplier when the at least one tag value indicates a zero value. The apparatus may disable updating of zero-value activations.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a neural network in accordance with aspects of the present disclosure.

FIG. 2 is a block diagram illustrating an exemplary deep convolutional network (DCN) in accordance with aspects of the present disclosure.

FIG. 3 is a diagram illustrating an example of a device that reduces power consumption for a sparse neural network.

FIG. 4 is a diagram illustrating an example of a data gating circuit that prevents output wires of the operand storage from toggling.

FIG. 5 is a diagram illustrating an example of a modified multiplier-accumulator unit that bypasses the multiplier and adder when at least one of the operands for the multiplier is zero.

FIG. 6 is a flowchart of a method of reducing power consumption for a neural network.

FIG. 7 is a conceptual data flow diagram illustrating the data flow between different means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computing systems for artificial neural networks will now be presented with reference to various apparatus and methods. The apparatus and methods will be described in the following detailed description and illustrated in the accompanying drawings by various blocks, components, circuits, processes, algorithms, etc. (collectively referred to as “elements”). The elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

An artificial neural network may be defined by three types of parameters: 1) the interconnection pattern between the different layers of neurons; 2) the learning process for updating the weights of the interconnections; 3) the activation function that converts a neuron's weighted input to its output activation. Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

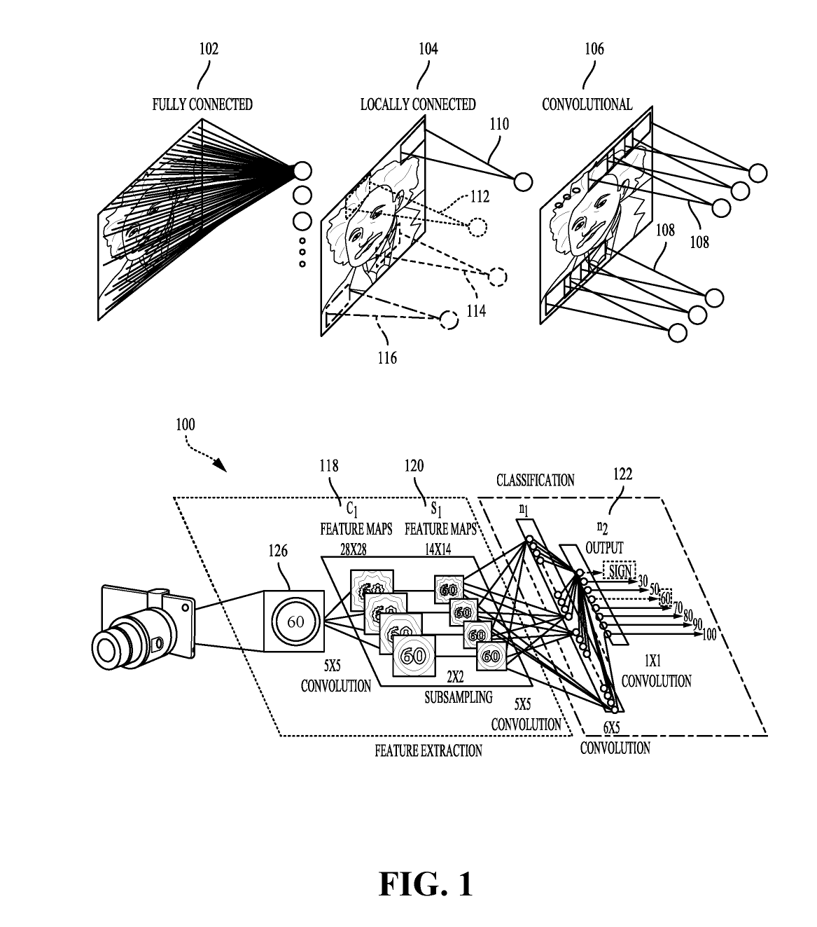

FIG. 1 is a diagram illustrating a neural network in accordance with aspects of the present disclosure. As shown in FIG. 1, the connections between layers of a neural network may be fully connected 102 or locally connected 104. In a fully connected network 102, a neuron in a first layer may communicate its output to every neuron in a second layer, so that each neuron in the second layer will receive input from every neuron in the first layer. Alternatively, in a locally connected network 104, a neuron in a first layer may be connected to a limited number of neurons in the second layer. A convolutional network 106 may be locally connected, and is further configured such that the connection strengths associated with the inputs for each neuron in the second layer are shared (e.g., 108). More generally, a locally connected layer of a network may be configured so that each neuron in a layer will have the same or a similar connectivity pattern, but with connections strengths that may have different values (e.g., 110, 112, 114, and 116). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 100 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A deep convolutional network (DCN) may be trained with supervised learning. During training, a DCN may be presented with an image, such as a cropped image of a speed limit sign 126, and a “forward pass” may then be computed to produce an output 122. The output 122 may be a vector of values corresponding to features such as “sign,” “60,” and “100.” The network designer may want the DCN to output a high score for some of the neurons in the output feature vector, for example the ones corresponding to “sign” and “60” as shown in the output 122 for a network 100 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 126 and a forward pass through the network may yield an output 122 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 118 and 120, with each element of the feature map (e.g., 120) receiving input from a range of neurons in the previous layer (e.g., 118) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

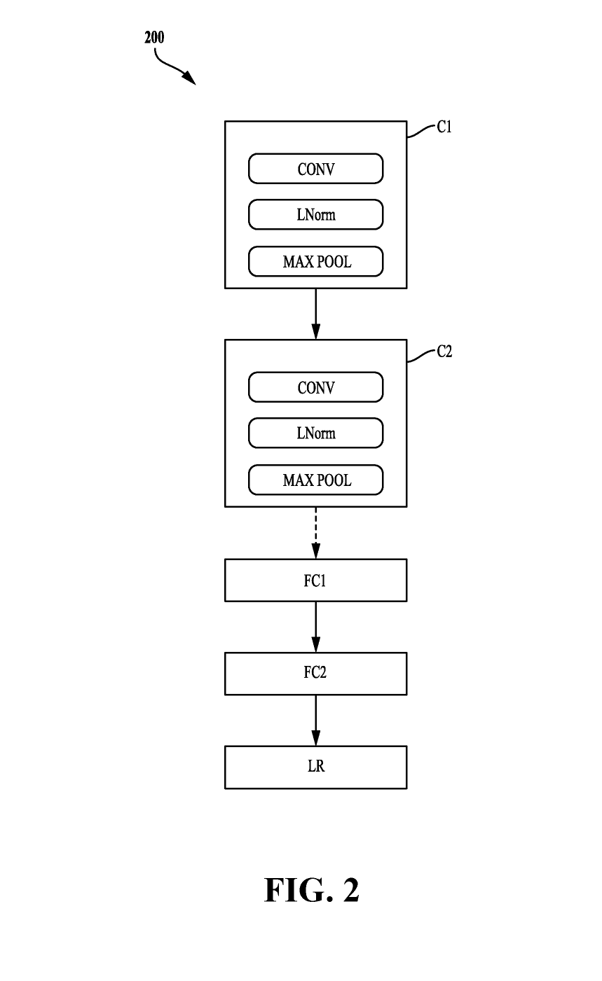

FIG. 2 is a block diagram illustrating an exemplary deep convolutional network 200. The deep convolutional network 200 may include multiple different types of layers based on connectivity and weight sharing. As shown in FIG. 2, the exemplary deep convolutional network 200 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 200 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU or GPU of an SOC, optionally based on an Advanced RISC Machine (ARM) instruction set, to achieve high performance and low power consumption. In alternative embodiments, the parallel filter banks may be loaded on the DSP or an image signal processor (ISP) of an SOC. In addition, the DCN may access other processing blocks that may be present on the SOC, such as processing blocks dedicated to sensors and navigation.

The deep convolutional network 200 may also include one or more fully connected layers (e.g., FC1 and FC2). The deep convolutional network 200 may further include a logistic regression (LR) layer. Between each layer of the deep convolutional network 200 are weights (not shown) that are to be updated. The output of each layer may serve as an input of a succeeding layer in the deep convolutional network 200 to learn hierarchical feature representations from input data (e.g., images, audio, video, sensor data and/or other input data) supplied at the first convolution block C1.

The network 100 or the deep convolutional network 200 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The network 100 or the deep convolutional network 200 may be utilized in a large range of applications, such as image and pattern recognition, machine learning, motor control, and the like. Each neuron in the neural network 100 or the deep convolutional network 200 may be implemented as a neuron circuit.

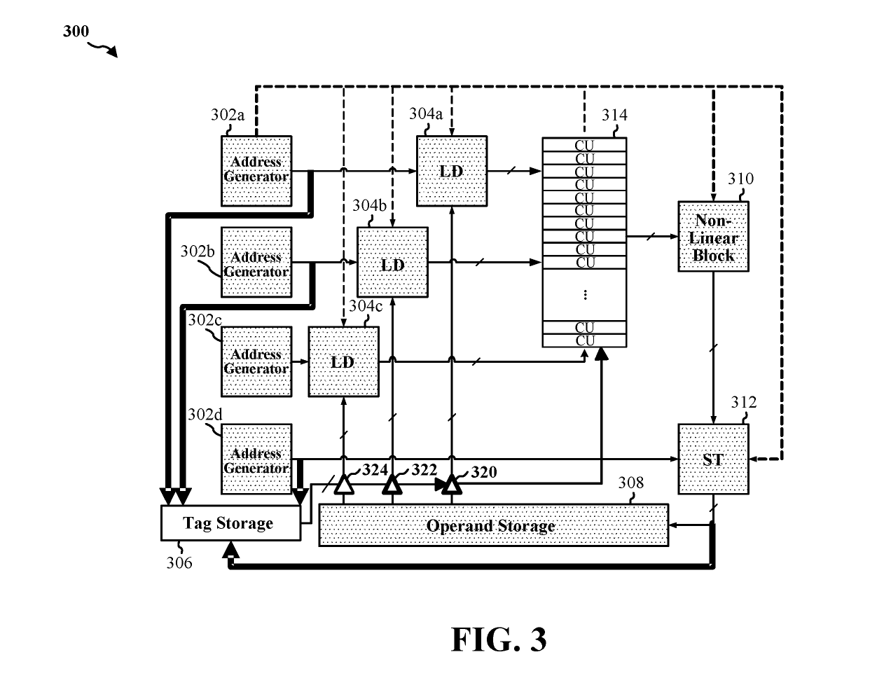

In certain aspects, the network 100 or the deep convolutional network 200 may be configured to reduce power consumption by taking sparsity of weights and activations in the neural network into consideration. For example, the network 100 or the deep convolutional network 200 may be configured to avoid fetching zero-valued operands, avoid multiplying by zero-valued operands, and avoid accumulating zero-valued operands, as will be described below with reference to FIGS. 3-8.

FIG. 3 is a diagram illustrating an example of a device 300 that reduces power consumption for a sparse neural network. The device 300 may be any computing device. In one configuration, the device 300 may include a hardware accelerator that is configured to avoid fetching zero-valued operands, avoid multiplying by zero-valued operands, and avoid accumulating zero-valued operands. As illustrated in FIG. 3, the device 300 may include several address generators 302, several load units 304, several computation units 314, a non-linear block 310, a store unit 312, an operand storage 308, a tag storage 306, and three data gating circuits 320, 322, 324.

Each of the computation units 314 may include a multiplier-accumulator (MAC) unit that computes the product of two operands and adds the product to an accumulator, in which computed product of operands is accumulated and stored. In one configuration, the computation units 314 may perform computation/calculation for the neural network. A MAC unit may include a multiplier followed by an adder and an accumulator register that stores the output of the adder. The output of the multiplier may be provided to a first input of the adder. The output of the accumulator register may be fed back to a second input of the adder, so that on each clock cycle, the output of the multiplier is added to the accumulator register. In one configuration, the multiplier may be implemented in combinational logic.

The operand storage 308 may be a memory or a cache for storing operands that are to be loaded to the multipliers of the computation units 314. In one configuration, for each pair of operands, the first operand may be a weight of the neural network, and the second operand may be an activation of the neural network.

The tag storage 306 may be a memory or cache for storing tags for operands. Each operand stored in the operand storage 308 may have a corresponding tag stored in the tag storage 306. Each tag may indicate whether or not the corresponding operand in the operand storage 308 is zero. In one configuration, each tag in the tag storage 306 may occupy a single bit. A first value of the single bit (e.g., ‘1’) may indicate that the corresponding operand in the operand storage 308 is zero, and a second value of the single bit (e.g., ‘0’) may indicate that the corresponding operand in the operand storage 308 is not zero. In one configuration, the tag storage 306 and the operand storage 308 may reside in different physical memories or caches. In one configuration, the tag storage 306 and the operand storage 308 may reside in the same physical memory or cache. For example, one bit of the one or more bytes for storing an operand may be reserved for storing the tag corresponding the operand. In one configuration, an operand in the operand storage 308 and the corresponding tag in the tag storage 306 may share the same address. For example, one address may point to one or more bytes in the memory or cache, of which one bit may be reserved for storing a tag and the rest of bits may be reserved for storing the corresponding operand. The area or power overhead for the tag storage 306 may be low. For example, the tag for each operand may occupy 1 bit of storage space. As a result, the power consumed for accessing the tag may be low.

The load units 304 may be configured to load operands from the operand storage 308 to the computation units 314. Specifically, a load unit (e.g., 304a, 304b, or 304c) may load a pair of operands from the operand storage 308 to a multiplier within a computation unit 314.

The non-linear block 310 may be configured to receive an output of a computation unit 314 and perform a non-linear operation on the output of the computation unit 314. The non-linear operation may be an operation of which the output is not directly proportional to the input. In one configuration, the non-linear block 310 may be a rectified linear unit (ReLU). In one configuration, the non-linear block 310 may perform at least a portion of an activation function for a neuron of the neural network.

The store unit 312 may receive output of the non-linear block 310 and store the output of the non-linear block 310 into the operand storage 308. In one configuration, the output of the non-linear block 310 may include an updated activation for the neural network.

The address generators 302 may be configured to generate addresses for accessing the operand storage 308 and/or the tag storage 306. In one configuration, an address generator (e.g., 302a) may generate the addresses for a pair of operands that are to be loaded to a multiplier within a computation unit 314, and send the addresses to a load unit (e.g., 304a), which may load the pair of operands from the operand storage 308 based on the addresses. In one configuration, the address generator (e.g., 302a) may also generate the addresses for a pair of tags corresponding to the pair of operands, and read the pair of tags from the tag storage 306 based on the addresses. In one configuration, an address generator (e.g., 302d) may generate the address for an output of the non-linear block 310, and send the address to the store unit 312, which may store the output of the non-linear block 310 to the operand storage 308 based on the address.

Each of the data gating circuits 320, 322, 324 may be placed between outputs of the operand storage 308 and inputs of a load unit (e.g., 304a, 304b, or 304c). Each data gating circuit (e.g., 320) may be configured to prevent the output wires of the operand storage 308 for both operands of a pair of operands from toggling if at least one operand of the pair of operands is zero. To determine whether or not at least one operand of the pair of operands is zero, one or both of the two tags corresponding to the pair of operands in the tag storage 306 may be accessed before the pair of operands are accessed in the operand storage 308. If at least one of the two tags corresponding to the pair of operands indicates a zero value, the data gating circuit (e.g., 320) may prevent the output wires for both operands from toggling, thus saving power in output wires as well as in the MAC unit to which the pair of operands are supposed to be loaded.

In one configuration, for each pair of operands that are to be loaded by a load unit (e.g., 304a) to a multiplier within a computation unit 314, a data gating circuit (e.g., 320) may read one or both of the two tags corresponding to the pair of operands from the tag storage 306 before the pair of operands are fetched from the operand storage 308. If at least one of the two tags corresponding to the pair of operands indicates a zero value, which means at least one of the pair of operands is zero, the data gating circuit (e.g., 320) may prevent the output wires for both operands of the pair of operands from toggling, thus saving the power/energy for fetching the pair of operands from the operand storage 308 to the computation unit.

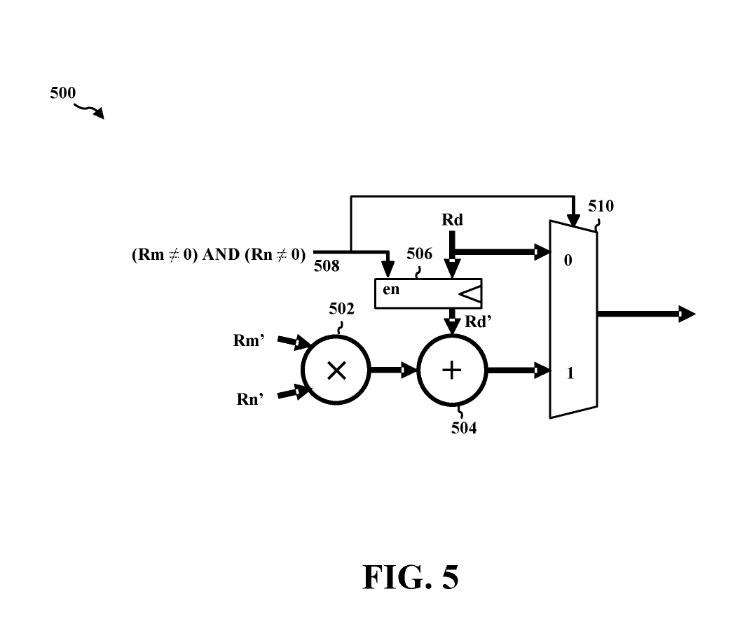

Further, the computation unit may read one or both of the two tags corresponding to the pair of operands from the tag storage 306 before a previously accumulated value is fetched from the accumulator register (not shown) of the MAC unit. If at least one of the two tags corresponding to the pair of operands indicates a zero value, the MAC unit may prevent the output wire of the accumulator register or the output of the accumulator register from toggling, thus saving the power/energy for fetching the previously accumulated value from the accumulator register. The MAC unit may also discard the output of the adder of the MAC unit if at least one of the two tags corresponding to the pair of operands indicates a zero value. Instead, the MAC unit may use the previously accumulated value as the new accumulated value when at least one of the two tags corresponding to the pair of operands indicates a zero value. In one configuration, the MAC unit may bypass the multiplier and adder if at least one of the two tags corresponding to the pair of operands indicates a zero value, thus saving power of performing the calculations. The details of the MAC unit will be described below in more details with reference to FIG. 5.

In one configuration, when an operand is stored or updated in the operand storage 308, a corresponding tag may be determined and stored or updated in the tag storage 306. The corresponding tag may indicate whether or not the operand is zero. In one configuration, if an operand is zero, the tag corresponding to the operand may be stored or updated in the tag storage 306 to indicate the operand is zero, while the value of the operand may not be stored or updated in the operand storage 308, thus saving the power for storing or updating the operand in the operand storage 308. In one configuration, before a first operand of a pair of operands is stored or updated in the operand storage 308, a corresponding tag of a second operand of the pair of operands may be read from the tag storage 306. If the corresponding tag of the second operand indicates that the second operand is zero, the value of the first operand may not be stored or updated in the operand storage 308, thus saving the power for storing or updating the first operand in the operand storage 308.

For example, when the store unit 312 receives an output of the non-linear block 310, the store unit 312 may determine whether the output of the non-linear block 310 is zero. If the output of the non-linear block 310 is zero, the store unit 312 may store or update a first tag in the tag storage 306 for a first operand corresponding to the output of the non-linear block 310, while bypassing storing or updating the first operand in the operand storage 308. If the output of the non-linear block 310 is not zero, the store unit 312 may determine whether or not a second tag for a second operand paired with the first operand indicates the second operand is zero. If the second operand is zero, the store unit 312 may store or update the first tag in the tag storage 306 for the first operand corresponding to the output of the non-linear block 310, while bypassing storing or updating the first operand in the operand storage 308. If both the first operand the second operand are not zero, the store unit 312 may store or update the first tag in the tag storage 306 for the first operand corresponding to the output of the non-linear block 310, and store or update the first operand in the operand storage 308.

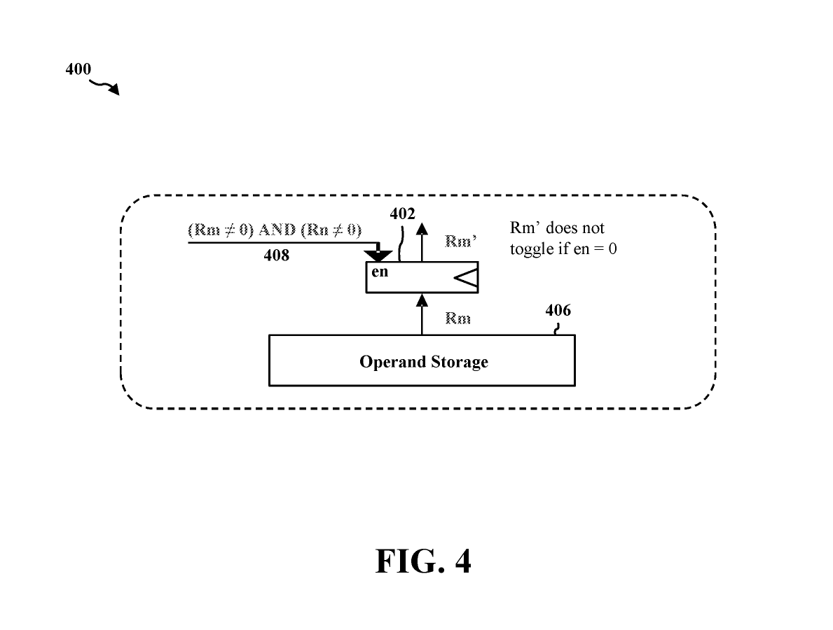

FIG. 4 is a diagram 400 illustrating an example of a data gating circuit 402 that prevents output wires of the operand storage 406 from toggling. In one configuration, the operand storage 406 may be the operand storage 308 described above with reference to FIG. 3, and the data gating circuit 402 may be the data gating circuit 320, 322, or 324 described above with reference to FIG. 3. In one configuration, the data gating circuit 402 may be a register (e.g., a flip-flop). In one configuration, the data gating circuit 402 may be a tri-state buffer.

As illustrated, the data gating circuit 402 may receive an operand Rₘ from the operand storage 406. The operand Rₘ may be propagated through the data gating circuit 402 and output as gated operand Rₘ′. The data gating circuit 402 may also receive an enable signal 408. The operand Rₘ and another operand Rₙ may form a pair of operands that are to be loaded to a multiplier of a MAC unit. The enable signal 408 may be dependent on whether or not both operands Rₘ and Rₙ are non-zero. In one configuration, if both operands Rₘ and Rₙ are non-zero, the enable signal 408 may be set to ‘1’, thus enabling the gated operand Rₘ′ to toggle (e.g., by enabling the gating circuit output to toggle). If at least one of operands Rₘ and Rₙ is zero, the enable signal 408 may be set to ‘0’, thus preventing the gated operand Rₘ′ from toggling.

In one configuration, in order to determine whether or not both operands Rₘ and Rₙ are non-zero, one or both of the two tags corresponding to the operands Rₘ and Rₙ are read from the tag storage 306, as described above with reference to FIG. 3. In one configuration, if at least one of operands Rₘ and Rₙ is zero, the gated operand Rₘ′ may not toggle, thus saving power for fetching the operand Rₘ.

FIG. 5 is a diagram illustrating an example of a modified multiplier-accumulator unit 500 that bypasses the multiplier and adder when at least one of the operands for the multiplier is zero. In the example, the MAC unit 500 may include a multiplier 502, an adder 504, a gating circuit 506, and a multiplexer 510.

The multiplier 502 may receive two operands Rₘ′ and Rₙ′. In one configuration, each of the operands Rₘ′ and Rₙ′ may be the output of the data gating circuit 402 described above with reference to FIG. 4. In such a configuration, the operands Rₘ′ and Rₙ′ may be gated values of operands Rₘ and Rₙ. The multiplier 502 may output the product of the operands Rₘ′ and Rₙ′.

In one configuration, the gating circuit 506 may be a register (e.g., a flip-flop). In one configuration, the gating circuit 506 may be a tri-state buffer. As illustrated, the gating circuit 506 may receive a previously accumulated value R_{d} from the accumulator register (not shown). The previously accumulated value R_{d} may be propagated through the gating circuit 506 and output as gated accumulated value R_{d}′. The gating circuit 506 may also receive an enable signal 508. The enable signal 508 may be dependent on whether or not both operands Rₘ and Rₙ are non-zero. In one configuration, if both operands Rₘ and Rₙ are non-zero, the enable signal 508 may be set to ‘1’, thus enabling the gated accumulated value R_{d}′ to toggle or to be propagated. If at least one of operands Rₘ and Rₙ is zero, the enable signal 508 may be set to ‘0’, thus preventing the gated accumulated value R_{d}′ from toggling or being propagated. In one configuration, the enable signal 508 may be equivalent to the enable signal 408 described above with reference to FIG. 4.

In one configuration, in order to determine whether or not both operands Rₘ and Rₙ are non-zero, one or both of the two tags corresponding to the operands Rₘ and Rₙ are read from the tag storage 306, as described above with reference to FIG. 3. In one configuration, if at least one of operands Rₘ and Rₙ is zero, the gated accumulated value R_{d}′ may not toggle or be propagated, thus saving power for fetching the previously accumulated value R_{d}.

The adder 504 receives one input from the output of the multiplier 502 and another input from the output of the gating circuit 506, and outputs the sum of the gated accumulated value R_{d}′ and the product of the operands Rₘ′ and Rₙ′.

The multiplexer 510 may receive the previously accumulated value R_{d} as a first input and the output of the adder 504 as a second input. The multiplexer 510 may receive the enable signal 508 as a control signal. In one configuration, if the enable signal 508 is ‘1’, which means that both of the operands Rₘ and Rₙ are non-zero, the multiplexer 510 may select the output of the adder 504 as the output of the multiplexer 510. If the enable signal 508 is ‘0’, which means that at least one of the operands Rₘ and Rₙ is zero, the multiplexer 510 may select the previously accumulated value R_{d} as the output of the multiplexer 510. The output of the multiplexer 510 may be stored into the accumulator register (not shown) as the new accumulated value. Therefore, if at least one of the operands Rₘ and Rₙ is zero, the MAC unit 500 may bypass the multiplier 502 and the adder 504, and select the previously accumulated value R_{d} as the new accumulated value.

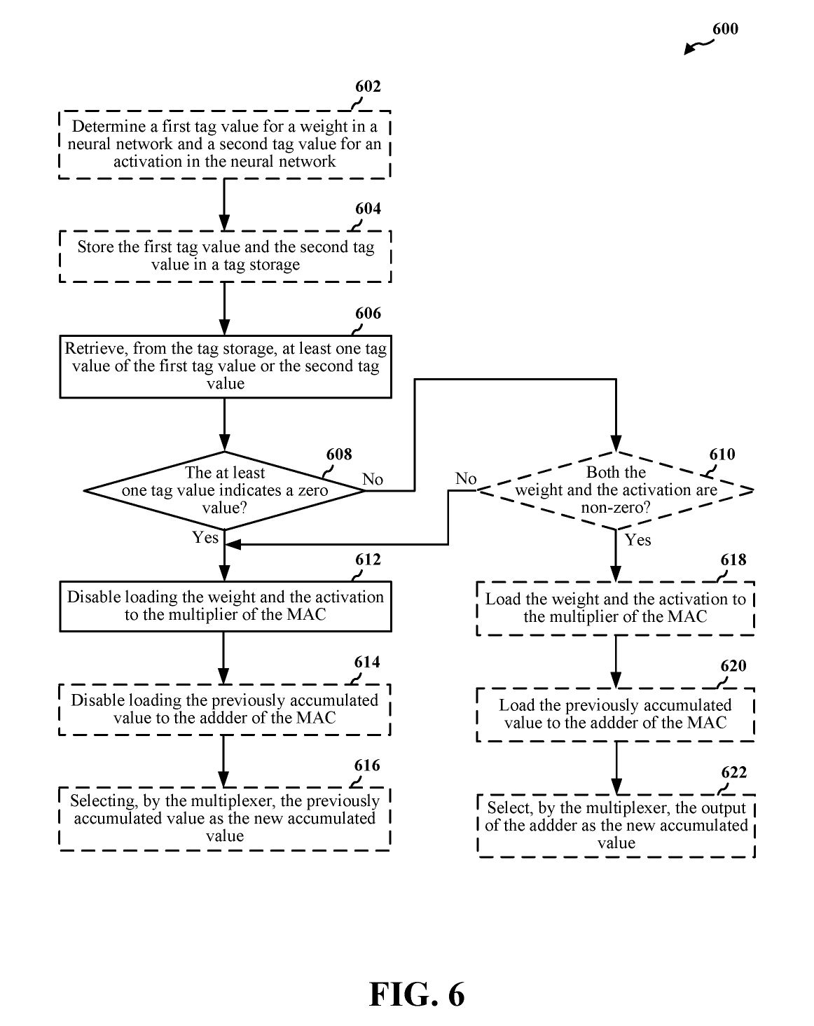

FIG. 6 is a flowchart 600 of a method of reducing power consumption for a neural network. In one configuration, the neural network may be a deep convolutional neural network (DCN). The method may be performed by a computing device (e.g., the device 300 or the apparatus 702/702′). At 602, the device may optionally determine a first tag value for a weight in the neural network and a second tag value for an activation in the neural network. The first tag value may indicate whether the weight is zero and the second tag value may indicate whether the activation is zero. The weight and the activation may form a pair of operands that are to be loaded to a multiplier (e.g., the multiplier 502) of the MAC (e.g., the MAC unit 500, which may be within a computation unit 314). In one configuration, in order to determine whether a weight or an activation is zero or not, the weight or activation may be compared to a zero value. In one configuration, a tag may be set to 1 to indicate a zero value, and set to 0 to indicate a non-zero value. In one configuration, a tag may be set to 0 to indicate a zero value, and set to 1 to indicate a non-zero value. In one configuration, the weight and activation may be stored in an operand storage (e.g., the operand storage 308).

At 604, the device may optionally store the first tag value and the second tag value in a tag storage (e.g., the tag storage 306). In one configuration, the device may update the second tag value at the tag storage when the activation is updated. In one configuration, the device may disable updating the activation in the operand storage when the second tag value indicates that the activation is zero. In one configuration, even though the second tag value may indicate the activation is not zero, the device may disable updating the activation in the operand storage when the first tag value indicates that the weight is zero.

At 606, the device may retrieve, from the tag storage, at least one tag value of the first tag value or the second tag value. In one configuration, the device may retrieve one tag value (e.g., the first tag value or the second tag value) first. If the retrieved tag value indicates a non-zero value, the device may retrieve the other tag value.

At 608, the device may determine whether or not the at least one tag value indicates a zero value for the weight or the activation. If the at least one tag value indicates a zero value for the weight or the activation, the device may proceed to 612. If the at least one tag value indicates that the weight or the activation is not zero, the device may proceed to 610.

At 612, the device may disable loading the weight and the activation to the multiplier of the MAC. In one configuration, to disable the loading of the weight and the activation to the multiplier, the device may prevent output lines of the operand storage for outputting the weight and the activation from toggling. In one configuration, the device may disable the loading of the weight and the activation to the multiplier using a data gating circuit (e.g., the data gating circuit 320, 322, 324, or 402).

At 614, the device may optionally disable loading the previously accumulated value from a storage to the adder (e.g., the adder 504) of the MAC. In one configuration, to disable the loading of the previously accumulated value from the storage to the adder, the device may prevent an output line of the storage storing the previously accumulated value (e.g., the accumulator register) from toggling. In one configuration, the device may disable the loading of the previously accumulated value from the storage to the adder using a gating circuit (e.g., the gating circuit 506 between the storage and the adder).

At 616, the device may optionally select, by a multiplexer (e.g., the multiplexer 510), the previously accumulated value as the new accumulated value. In one configuration, a first input of the multiplexer may be the previously accumulated value, and a second input of the multiplexer may be the output of the adder. For example, when at least one of the weight or activation is zero, the multiplexer may receive a control signal that is set to 0, which may select the first input of the multiplexer as the output of the multiplexer. As a result, the previously accumulated value is selected as the output of the multiplexer and is stored to the accumulator register as the new accumulated value.

At 610, the device may optionally determine whether or not both the weight and the activation are non-zero. If both the weight and the activation are non-zero, the device may proceed to 618. If one of the weight and activation is non-zero but the other is zero, the device may proceed to 612.

At 618, the device may optionally load the weight and the activation to the multiplier of the MAC. In one configuration, the multiplier may compute the product of the weight and the activation, and provide the product of the weight and the activation as an input to the adder.

At 620, the device may optionally load the previously accumulated value to the addder of the MAC. In one configuration, the adder may compute the sum of the previously accumulated value and the product of the weight and the activation, and provide the sum as an input to the multiplexer.

At 622, the device may optionally select, by the multiplexer, the output of the addder as the new accumulated value. For example, when both the weight and the activation is non-zero, the multiplexer may receive a control signal that is set to 1, which may select the second input of the multiplexer as the output of the multiplexer. As a result, the output of the adder is selected as the output of the multiplexer and is stored to the accumulator register as the new accumulated value.

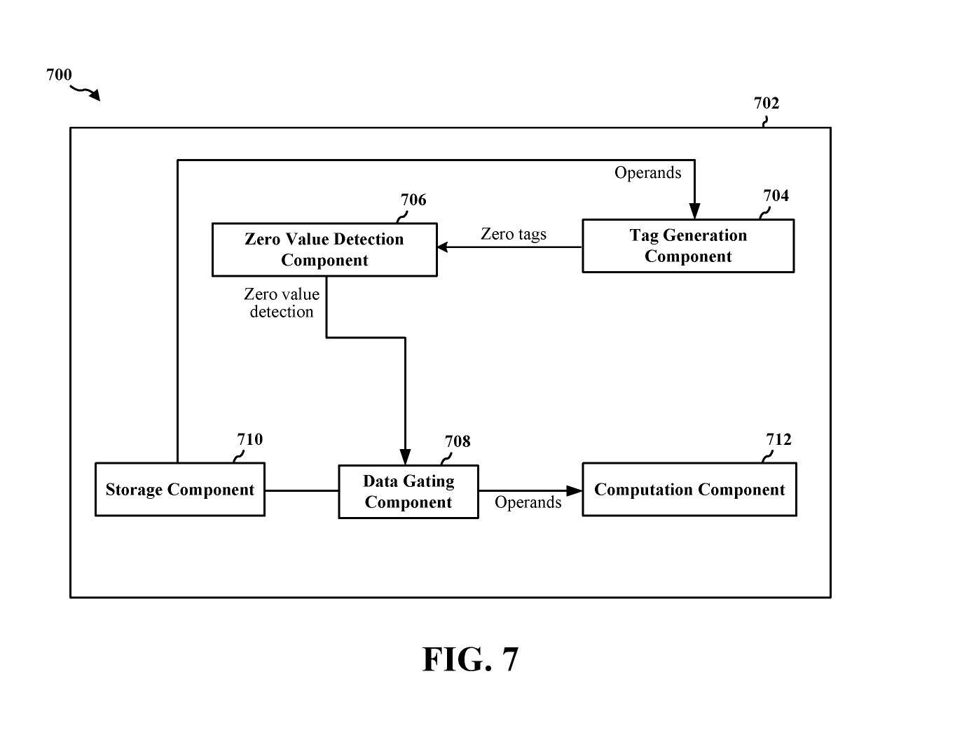

FIG. 7 is a conceptual data flow diagram 700 illustrating the data flow between different means/components in an exemplary apparatus 702. The apparatus 702 may be a computing device (e.g., the device 300). The apparatus 702 may include a storage component 710 that stores operands that are to be loaded to multipliers of MAC units. In one configuration, the storage component 710 may include the operand storage 308 described above.

The apparatus 702 may include a tag generation component 704 that generates zero tags for operands stored in the storage component 710. Each zero tag may indicate whether or not the corresponding operand is zero. In one configuration, the zero tags may be stored in a tag storage (e.g., the tag storage 306). In one configuration, the tag generation component 704 may perform operations described above with reference to 602 or 604 in FIG. 6. In one configuration, a tag value may be stored for each operand, each tag value may be initialized based on the initial value of the corresponding operand.

The apparatus 702 may include a zero value detection component 706 that detects whether or not at least one operand of a pair of operands is zero based on the corresponding zero tags. The pair of operands may include a weight of a neural network and an activation of the neural network. In one configuration, the zero value detection component 706 may perform operations described above with reference to 606, 608, or 610 in FIG. 6.

The apparatus 702 may include a computation component 712 that computes a product for each pair of operands. In one configuration, the computation component 712 may include the computation units 314 described above with reference to FIG. 3.

The apparatus 702 may include a data gating component 708 that enables or disables the loading of operands from the storage component 710 to the computation component 712 based on the zero value detection received from the zero value detection component 706. In one configuration, the data gating component 708 may include the data gating circuits 320, 322, 324, or 402 described above. In one configuration, the data gating component 708 may perform operations described above with reference to 612 or 618 in FIG. 6.

The apparatus may include additional components that perform each of the blocks of the algorithm in the aforementioned flowcharts of FIG. 6. As such, each block in the aforementioned flowcharts of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

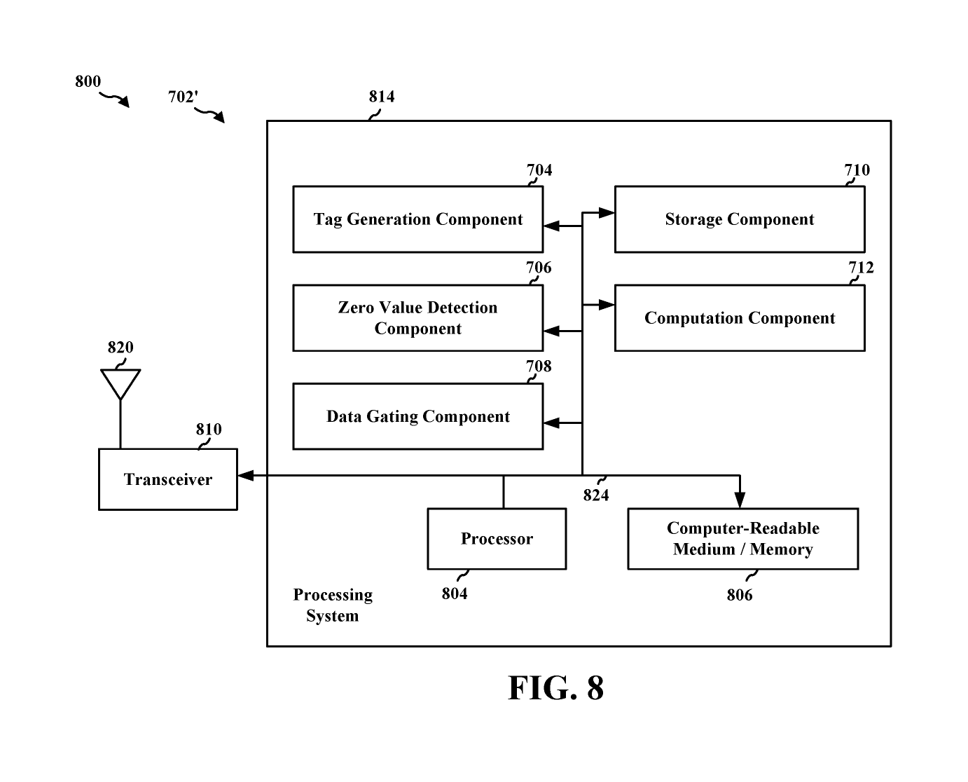

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, 712, and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 may be coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814. In addition, the transceiver 810 receives information from the processing system 814, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 710, 712. The components may be software components running in the processor 804, resident/stored in the computer readable medium/memory 806, one or more hardware components coupled to the processor 804, or some combination thereof.

In one configuration, the apparatus 702/702′ may include means for retrieving at least one tag value of a first tag value for a weight in the neural network or a second tag value for an activation in the neural network. In one configuration, the means for retrieving at least one tag value of a first tag value or a second tag value may perform operations described above with reference to 606 in FIG. 6. In one configuration, the means for retrieving at least one tag value of a first tag value or a second tag value may include the address generators 302, the load units 304, or the processor 804.

In one configuration, the apparatus 702/702′ may include means for determining whether the at least one tag value indicates a zero value. In one configuration, the means for determining whether the at least one tag value indicates a zero value may perform operations described above with reference to 608 in FIG. 6. In one configuration, the means for determining whether the at least one tag value indicates a zero value may include the zero value detection component 706 or the processor 804.

In one configuration, the apparatus 702/702′ may include means for disabling loading the weight and the activation to the multiplier when the at least one tag value indicates the zero value. In one configuration, the means for disabling loading the weight and the activation to the multiplier may perform operations described above with reference to 612 in FIG. 6. In one configuration, the means for disabling loading the weight and the activation to the multiplier may include the data gating circuit 320, 322, 324, or 402, or the data gating component 708. In one configuration, the means for disabling the loading of the weight and the activation to the multiplier may be configured to prevent output lines of the operand storage for outputting the weight and the activation from toggling.

In one configuration, the apparatus 702/702′ may include means for updating the second tag value at the tag storage when the activation is updated. In one configuration, the means for updating the second tag value at the tag storage when the activation is updated may include the store unit 312, the address generators 302, or the processor 804.

In one configuration, the apparatus 702/702′ may include means for disabling updating the activation in the operand storage when the second tag value indicates that the activation is zero. In one configuration, the means for disabling updating the activation in the operand storage may include the store unit 312 or the processor 804.

In one configuration, the apparatus 702/702′ may include means for disabling loading a previously accumulated value to an adder of the MAC when the at least one tag value indicates the zero value. In one configuration, the means for disabling loading a previously accumulated value to an adder of the MAC may perform operations described above with reference to 614 in FIG. 6. In one configuration, the means for disabling loading a previously accumulated value to an adder of the MAC may include the gating circuit 506. In one configuration, the means for disabling the loading of the previously accumulated value to the adder may be configured to prevent an output line of a storage storing the previously accumulated value from toggling.

In one configuration, the apparatus 702/702′ may include means for selecting the previously accumulated value as a new accumulated value when the at least one tag value indicates the zero value. In one configuration, the means for selecting the previously accumulated value as a new accumulated value may perform operations described above with reference to 616 in FIG. 6. In one configuration, the means for selecting the previously accumulated value as a new accumulated value may include the multiplexer 510, the computation component 712, or the processor 804.

In one configuration, the apparatus 702/702′ may include means for selecting the output of the adder as the new accumulated value when the first tag value and the second tag value indicate that both the weight and the activation are non-zero. In one configuration, the means for electing the output of the adder as the new accumulated value may perform operations described above with reference to 622 in FIG. 6. In one configuration, the means for electing the output of the adder as the new accumulated value may include the multiplexer 510, the computation component 712, or the processor 804.

In one configuration, the apparatus 702/702′ may include means for determining the first tag value for the weight. In one configuration, the means for determining the first tag value for the weight may perform operations described above with reference to 602 in FIG. 6. In one configuration, the means for determining the first tag value for the weight may include the tag generation component 704 or the processor 804.

In one configuration, the apparatus 702/702′ may include means for determining the second tag value for the activation. In one configuration, the means for determining the second tag value for the activation may perform operations described above with reference to 602 in FIG. 6. In one configuration, the means for determining the second tag value for the activation may include the tag generation component 704 or the processor 804.

In one configuration, the apparatus 702/702′ may include means for storing the first tag value and the second tag value in the tag storage. In one configuration, the means for storing the first tag value and the second tag value in the tag storage may perform operations described above with reference to 604 in FIG. 6. In one configuration, the means for storing the first tag value and the second tag value in the tag storage may include the tag generation component 704 or the processor 804.

The aforementioned means may be one or more of the aforementioned components of the apparatus 702 and/or the processing system 814 of the apparatus 702′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of reducing power consumption of a neural network, comprising:
retrieving, from a tag storage, at least one tag value of a first tag value for a weight in the neural network or a second tag value for an activation in the neural network, the first tag value indicating whether the weight is zero and the second tag value indicating whether the activation is zero, wherein the weight and the activation are to be loaded to a multiplier of a multiplier-accumulator (MAC) as a pair of operands;
determining whether the at least one tag value indicates a zero value; and
disabling loading the weight and the activation to the multiplier when the at least one tag value indicates the zero value.

2. The method of claim 1, wherein the weight and the activation are stored in an operand storage.

3. The method of claim 2, wherein the disabling the loading of the weight and the activation to the multiplier comprises preventing output lines of the operand storage for outputting the weight and the activation from toggling.

4. The method of claim 2, further comprising:
updating the second tag value at the tag storage when the activation is updated; and
disabling updating the activation in the operand storage when the second tag value indicates that the activation is zero.

5. The method of claim 1, wherein the neural network is a deep convolutional neural network (DCN).

6. The method of claim 1, further comprising:
disabling loading a previously accumulated value to an adder of the MAC when the at least one tag value indicates the zero value.

7. The method of claim 6, wherein the disabling the loading of the previously accumulated value to the adder comprises preventing an output line of a storage storing the previously accumulated value from toggling.

8. The method of claim 6, further comprising selecting, by a multiplexer, the previously accumulated value as a new accumulated value when the at least one tag value indicates the zero value, a first input of the multiplexer being the previously accumulated value, a second input of the multiplexer being an output of the adder.

9. The method of claim 8, further comprising selecting, by the multiplexer, the output of the adder as the new accumulated value when the first tag value and the second tag value indicate that both the weight and the activation are non-zero.

10. The method of claim 1, further comprising:
determining the first tag value for the weight;
determining the second tag value for the activation; and
storing the first tag value and the second tag value in the tag storage.

11. An apparatus for reducing power consumption of a neural network, comprising:
means for retrieving, from a tag storage, at least one tag value of a first tag value for a weight in the neural network or a second tag value for an activation in the neural network, the first tag value indicating whether the weight is zero and the second tag value indicating whether the activation is zero, wherein the weight and the activation are to be loaded to a multiplier of a multiplier-accumulator (MAC) as a pair of operands;
means for determining whether the at least one tag value indicates a zero value; and
means for disabling loading the weight and the activation to the multiplier when the at least one tag value indicates the zero value.

12. The apparatus of claim 11, wherein the weight and the activation are stored in an operand storage.

13. The apparatus of claim 12, wherein the means for disabling loading the weight and the activation to the multiplier is configured to prevent output lines of the operand storage for outputting the weight and the activation from toggling.

14. The apparatus of claim 12, further comprising:
means for updating the second tag value at the tag storage when the activation is updated; and
means for disabling updating the activation in the operand storage when the second tag value indicates that the activation is zero.

15. The apparatus of claim 11, wherein the neural network is a deep convolutional neural network (DCN).

16. The apparatus of claim 11, further comprising:
means for disabling loading a previously accumulated value to an adder of the MAC when the at least one tag value indicates the zero value.

17. The apparatus of claim 16, wherein the means for disabling loading the previously accumulated value to the adder is configured to prevent an output line of a storage storing the previously accumulated value from toggling.

18. The apparatus of claim 16, further comprising means for selecting the previously accumulated value as a new accumulated value when the at least one tag value indicates the zero value.

19. The apparatus of claim 18, further comprising means for selecting an output of the adder as the new accumulated value when the first tag value and the second tag value indicate that both the weight and the activation are non-zero.

20. The apparatus of claim 11, further comprising:
means for determining the first tag value for the weight;
means for determining the second tag value for the activation; and
means for storing the first tag value and the second tag value in the tag storage.

21. An apparatus for reducing power consumption of a neural network, comprising:
a tag storage;
at least one processor configured to:
retrieve, from the tag storage, at least one tag value of a first tag value for a weight in the neural network or a second tag value for an activation in the neural network, the first tag value indicating whether the weight is zero and the second tag value indicating whether the activation is zero, wherein the weight and the activation are to be loaded to a multiplier of a multiplier-accumulator (MAC) as a pair of operands; and
determine whether the at least one tag value indicates a zero value; and
a gating circuit configured to disable loading the weight and the activation to the multiplier when the at least one tag value indicates the zero value.

22. The apparatus of claim 21, wherein the weight and the activation are stored in an operand storage.

23. The apparatus of claim 22, wherein, to disable the loading of the weight and the activation to the multiplier, the gating circuit is configured to prevent output lines of the operand storage for outputting the weight and the activation from toggling.

24. The apparatus of claim 22, wherein the at least one processor is further configured to:
update the second tag value at the tag storage when the activation is updated; and
disable updating the activation in the operand storage when the second tag value indicates that the activation is zero.

25. The apparatus of claim 21, further comprising a second gating circuit configured to:
disable loading a previously accumulated value to an adder of the MAC when the at least one tag value indicates the zero value.

26. The apparatus of claim 25, wherein, to disable the loading of the previously accumulated value to the adder, the second gating circuit is configured to prevent an output line of a storage storing the previously accumulated value from toggling.

27. The apparatus of claim 25, further comprising a multiplexer configured to select the previously accumulated value as a new accumulated value when the at least one tag value indicates the zero value, a first input of the multiplexer being the previously accumulated value, a second input of the multiplexer being an output of the adder.

28. The apparatus of claim 27, wherein the multiplexer is further configured to select the output of the adder as the new accumulated value when the first tag value and the second tag value indicate that both the weight and the activation are non-zero.

29. The apparatus of claim 21, wherein the at least one processor is further configured to:
determine the first tag value for the weight;
determine the second tag value for the activation; and
store the first tag value and the second tag value in the tag storage.

30. A computer-readable medium storing computer executable code, comprising code to:
retrieve, from a tag storage, at least one tag value of a first tag value for a weight in a neural network or a second tag value for an activation in the neural network, the first tag value indicating whether the weight is zero and the second tag value indicating whether the activation is zero, wherein the weight and the activation are to be loaded to a multiplier of a multiplier-accumulator (MAC) as a pair of operands;
determine whether the at least one tag value indicates a zero value; and
disable loading the weight and the activation to the multiplier when the at least one tag value indicates the zero value.
